(19) United States
(12) Patent Application Publication
(10) Pub. No.: US 2011/0056724 A1
(43) Pub. Date: Mar. 10, 2011

(54) METHOD OF PRODUCING HOLLOW CORE FOR COAXIAL CABLE, HOLLOW CORE FOR COAXIAL CABLE, AND COAXIAL CABLE

(75) Inventors: Seiji Tanaka, Tokyo (JP); Shigehiro Matsuno, Tokyo (JP); Masaya Suemori, Tokyo (JP)

(73) Assignee: UBE-NITTO KASEI CO., LTD., Tokyo (JP)

(21) Appl. No.: 12/922,848

(22) PCT Filed: Mar. 13, 2009
(86) PCT No.: PCT/JP2009/054847

§ 371 Date: Sep. 15, 2010

(30) Foreign Application Priority Data
Mar. 25, 2008 (JP) 2008-077889
May 30, 2008 (JP) 2008-142026
Sep. 2, 2008 (JP) 2008-224334

(51) Int. Cl. H01B 11/18; H01B 7/00; H01B 13/20

(52) U.S. Cl. 174/102 R; 174/110 R; 29/828

(57) ABSTRACT

To produce a hollow core for a coaxial cable having high hollow rate and stable electric characteristics in its longitudinal direction. A producing method of a hollow core for a coaxial cable, the hollow core comprising: an inner conductor; and an insulating coating body including an inner annular portion for coating the inner conductor, a plurality of ribs extending radially from the inner annular portion, and an outer annular portion having an outer diameter of 0.5 mm or less for connecting outer ends of the ribs with each other; in which the hollow core includes a plurality of hollow portions surrounded by the inner annular portion, the outer annular portion and the ribs, a ratio of an area of the hollow portion in the insulating portion is 40% or more, and a roundness of the outer annular portion is 96.0% or more, wherein the producing method comprises at least: a step (1) of extruding molten resin from the die that capable of forming the insulating coating body; a step (2) of heating a resin forming the insulating coating body; and a step (3) of cooling the resin forming the insulating coating body slowly at a temperature close to a room temperature.

### TECHNICAL FIELD

The present invention relates to a producing method a hollow core for a coaxial cable, the hollow core for a coaxial cable and a coaxial cable. More particularly, the invention relates to a technique concerning a hollow core for a coaxial cable having stable electric characteristics in its longitudinal direction although the hollow core has a high hollow rate.

### BACKGROUND ART

As information technology moves forward, a coaxial cable is also required to enhance its performance (reduction in loss, increase in transmission speed), and to enhance density (downsizing of cable). Therefore, it is required to lower a dielectric constant of an insulator, and to enhance its stability. To lower the dielectric constant of the insulator, it is effective to introduce air into an insulating coating resin, and a foam-type resin (PE, PFA, PTFE or the like) is used.

To prevent a hollow portion of the hollow core from being crushed or deformed, a skin layer (solid layer) is formed on a surface of the hollow core. However, since this layer is solid, a foaming degree (extent of foaming) of the entire coaxial cable hollow core can not be increased.

Especially when a core outer diameter of the coaxial cable hollow core is extremely thin as thin as 0.5 mm or less, an influence of spots caused when foams are formed is increased. Further, a rate of an area of the skin layer occupying the entire insulator is increased, and it is difficult to produce a coaxial cable hollow core having stable electric characteristics in its longitudinal direction while keeping a high foaming degree (high hollow rate).

Concerning this, the present applicant provided a technique concerning a hollow core for a coaxial cable in which an outer diameter of an outer annular portion was 5.0 mm or less, a rate of an area of a hollow portion in an insulating portion was 40% or more, and a roundness of the outer annular portion was 96.0% or more (see patent literature 1).

[Patent Literature 1] Japanese Unexamined Patent Application Publication No. 2007-335393

### SUMMARY OF THE INVENTION

### Technical Problem

However, when a hollow core for a coaxial cable is produced, there are the following problems.

When a thickness of the outer annular portion is thin for example, since heat capacity of a molten resin pushed out from a dice is small, the outer annular portion is rapidly cooled, and it is difficult to control draft. Therefore, the outer annular portion is cooled while keeping its large outer shape, a space is created between an inner annular portion and an inner conductor, so the inner annular portion can not coat the inner conductor uniformly. A cross section of a coating layer of its outer periphery that must be a perfect circle is crushed and becomes polygonal in shape in some cases. These problems appear conspicuously especially when a hollow core for a very thin coaxial cable is produced.

Hence, it is a main object of the present invention to provide a producing method of a hollow core for a very thin coaxial cable having stable electric characteristics in its longitudinal direction although the hollow core has a high hollow rate.

### Solution to Problem

The invention provides a producing method of a hollow core for a coaxial cable, the hollow core comprising:

an inner conductor; and

an insulating coating body including an inner annular portion for coating the inner conductor, a plurality of ribs extending radially from the inner annular portion, and an outer annular portion having an outer diameter of 0.5 mm or less for connecting outer ends of the ribs with each other; in which

the hollow core includes a plurality of hollow portions surrounded by the inner annular portion, the outer annular portion and the ribs, a ratio of an area of the hollow portion in an insulating portion is 40% or more, and a roundness of the outer annular portion is 96.0% or more, wherein

the producing method comprises at least:

a step (1) of extruding molten resin from the die that capable of forming the insulating coating body;

a step (2) of heating the resin forming the insulating coating body; and

a step (3) of cooling the resin forming the insulating coating body slowly at a temperature close to a room temperature.

The drafted resin is heated and slowly cooled to a temperature close to a room temperature. By this operation, a hollow core for a coaxial cable having high roundness can be obtained.

In the producing method of the hollow core for a coaxial cable according to the invention, it is preferable that the step (2) is carried out by a heating cylinder.

In the invention, it is preferable that a maximum outer diameter and a minimum outer diameter of the obtained hollow core are measured, and at least one of a heating temperature and heating time in the step (2) is controlled such that a difference between the maximum outer diameter and the minimum outer diameter becomes minimum. The outer diameter of the hollow core is measured, and the heating condition in the step (2) is controlled based on the measurement. Therefore, it is possible to control the roundness of the hollow core with high precision.

In the producing method of a hollow core for a coaxial cable of the invention, it is preferable that an area-drafting magnification ratio is in a range of 300 to 4000 times.

In the invention, it is preferable that the die includes an insertion center hole of the inner conductor, an inner annular hole formed adjacent to an outer periphery of the insertion center hole, a plurality of straight holes radially extending from an outer periphery of the inner annular hole, an outer annular hole connecting outer ends of the straight holes with each other, and a through hole through which inner-pressure adjusting air for forming the hollow portion is introduced into a portion surrounded by the inner annular hole, the outer annular hole and the straight holes.

The invention provides a hollow core for a coaxial cable comprising:

an inner conductor; and

an insulating coating body including an inner annular portion for coating the inner conductor, a plurality of ribs extending radially from the inner annular portion, and an outer annular portion having an outer diameter of 0.5 mm or less for connecting outer ends of the ribs with each other; in which

the hollow core includes a plurality of hollow portions surrounded by the inner annular portion, the outer annular portion and the ribs,

a ratio of an area of the hollow portion in the insulating portion is 40% or more, and a roundness of the outer annular portion is 96.0% or more, and

a rate of variability of an underwater capacitance in its longitudinal direction is 3.1% or less.

The hollow core for a coaxial cable having a high hollow rate and stable electric characteristics in its longitudinal direction can be obtained.

Here, “the rate of variability of underwater capacitance” is a value obtained by dividing a difference between the maximum underwater capacitance value and the minimum underwater capacitance value over 5 m of the hollow core for a coaxial cable by an average value.

The invention provides a coaxial cable in which at least an outer conductor layer is provided on one or a plurality of outer peripheries of the hollow core for the coaxial cable. In this coaxial cable, a rate of variability of a characteristic impedance in its longitudinal direction can be 3.0% or less.

Here, “the rate of variability of characteristic impedance” is a value obtained by dividing a difference between the maximum impedance value and the minimum impedance value over 5 m of the coaxial cable by an average value.

### ADVANTAGEOUS EFFECTS OF THE INVENTION

According to the present invention, it is possible to produce a hollow core for a coaxial cable having stable electric characteristics in its longitudinal direction although the hollow core has a high hollow rate.

### DESCRIPTION OF EMBODIMENTS

The present invention will be described below. Embodiments illustrated in the attached drawings are typical examples of the invention, and the scope of the invention is not interpreted narrower by these embodiments. In the drawings used here, a configuration of an apparatus shown here is simplified for the sake of convenience of description. First, a hollow core of the invention is described and then, a producing method is described.

FIG. 1 is a sectional view showing one example of the hollow core that can be obtained by the invention. A symbol 10 in FIG. 1 represents a coaxial cable hollow core (hereinafter, simply referred to as “hollow core” in some cases). The coaxial cable hollow core 10 includes an inner conductor 12 and an insulating coating body 14.

The inner conductor 12 may be a copper or copper alloy thin wire having excellent strength and conductivity, a solid wire plated with highly-conductive metal, or a twisted wire.

The insulating coating body 14 is made of thermoplastic resin, and includes an inner annular portion 14a coating an outer periphery of the inner conductor 12, six ribs 14b radially extending outwardly from an outer periphery of the inner annular portion 14a, and an outer annular portion 14c connecting between outer ends of the ribs 14b with each other.

In the hollow core 10, the six ribs 14b are disposed along its circumferential direction at substantially equal distances from each other. Thus, a hollow portion 16 is space surrounded by the inner annular portion 14a, the ribs 14b and the outer annular portion 14c. And six hollow portions 16 that are continuous in the longitudinal direction are disposed around the inner conductor 12 in the circumferential direction at substantially equal distances from one another.

A material of the insulating coating body 14 is not limited, and fluoroplastic such as PFA, polyolefin, cyclic polyolefin (APO), syndiotactic polystyrene (SPS), polymethylpentene (TPX), polyethylene naphthalate (PEN) and the like can be used. The insulating coating body 14 can integrally be formed of these resins.

According to the hollow core 10, after resin forming the insulating coating body 14 is extruded from a die 20, the resin is slowly cooled at about room temperature. An outer diameter of the outer annular portion 14c is 0.5 mm or less, a rate of an area of the hollow portion 16 in the insulating portion is 40% or more, and the roundness of the outer annular portion can be 96.0% or more. It is preferable that a rate of variability (“underwater capacitance rate of variability” in some cases) when the capacitance of the hollow core 10 is continuously measured underwater is 3.1% or less. The underwater capacitance rate of variability is a rate of variability obtained by dividing a difference between the maximum capacitance value and the minimum capacitance value over 5 m of the hollow core 10 in its longitudinal direction by an average value. According to the invention, the hollow core 10 having stable capacitance in its longitudinal direction can be obtained.

The hollow insulating structure of the invention can secure a hollow rate of 40% or more although it is very thin, but it is preferable that the number of the ribs is five or more to secure the roundness of the structure and the mechanical characteristics (lateral pressure, bending characteristics, and at the time of machining operation of a terminal of a cable). To secure the hollow rate of 40% or more and in view of the precision of the machining operation of the tip end of the die, it is preferable that the number of the ribs does not exceed ten.

In the cross-sectional area of the hollow core 10, the hollow rate is a rate of the area of the hollow portions 16 in the entire insulating portion. For example, in the case of the hollow core 10 shown in FIG. 10, the hollow rate is set such that a total sum of the cross-sectional area of the six hollow portions 16 occupies 40% or more of the insulating portion (total cross-sectional area of the insulating coating body 14 and the total cross-sectional area of the hollow portions 16).

The roundness is a value shown in the following equation (1) when the longest diameter of the outer diameter of the outer annular portion 14c is defined as a and the shortest diameter thereof is defined as b and the average outer diameter thereof is defined as c (c=(a+b)/2). The roundness is an index showing how much the hollow core 10 is close to the perfect circle.

[Math. 1]

Roundness (%)=(1−(a−b)/c)×100 (1)

It is preferable that an area-drafting magnification ratio is a value shown in the following equation (2), and a preferable range of this ratio is 300 to 4000 times. More preferably, its lower limit value is 800 times or more, and its upper limit value is 2000 times or less. If the area-drafting magnification ratio falls within the above range, it is preferable because the producing stability can further be enhanced.

$$\begin{matrix}[ Math . 2 ] & \\ Area \text{-} drafting magnification ratio ( \% ) = \frac{{( Outer diameter of die )}^{2}}{{( \begin{matrix}Outer diameter of outer \\ annular portion of \\ hollow core\end{matrix} )}^{2}} & ( 2 )\end{matrix}$$

By providing an outer conductor layer and its protecting layer (if necessary) on the outer periphery of the outer annular portion 14c of the insulating coating body 14, the hollow core 10 can be used as a coaxial cable. In this case, the outer conductor layer can be formed by plating metal and the like.

In this case, as activation processing of the insulating coating body 14, hydrophilic processing is carried out by etching using wet blast or fluoro etching (naphthalene.sodium complex) and then, sensitizing operation is carried out using hydrochloric acid liquid of tin(II) chloride, and activation is carried out using hydrochloric acid liquid of palladium (II) chloride. Then, electroless plating and the like can be carried out.

As the outer conductor layer, it is possible to combine a laterally wound wire shield, lateral winding or lengthwise winding of a metal plastic tape having metal layers on both surfaces or one surface thereof, a laterally wound wire shield including this metal plastic tape, a conductor layer in which tin is impregnated in a laterally wound shield, and a metal-plated layer directly formed by processing a surface of the hollow core 10.

When hollow core 10 is used as the coaxial cable, the present invention is not limited to a case where one hollow core 10 is used, and a plurality of hollow core bodies 10 may be used, and these cases are also covered by the invention.

A rate of variability of a characteristic impedance in the coaxial cable using the hollow core 10 in the longitudinal direction can be 3.0% or less. The rate of variability of the characteristic impedance is obtained by dividing a difference between the maximum impedance value and the minimum impedance value over 5 m of the coaxial cable by an average value. The electric characteristics of the hollow core 10 are stable although the hollow rate is high. Therefore, the coaxial cable obtained from this has stable characteristic impedance in the longitudinal direction. The characteristic impedance of the coaxial cable may be 50Ω or 75Ω, and it is possible to appropriately select one of them in accordance with a use or the like.

The hollow core 10 having the above-described configuration can be obtained by the following producing method. FIG. 2 is a conceptual diagram used for explaining the producing method of the invention. A symbol S represents a producing apparatus of the hollow core for the coaxial cable according to the invention (hereinafter, referred to as “producing apparatus” in some cases). The producing apparatus S includes the die 20 in an extruder, and the inner conductor 12 is introduced into the die 20 through a turn sheave 40. A heating cylinder (draft zone) 42, a slowly cooling air-cooling portion 44, and a water-cooling tank 45 are disposed downstream from the die 20. A water-receiving water tank 47 is provided below them. A noncontact thermometer 48 that is pulled out from the die 20 is provided between the air-cooling portion 44 and the water-cooling tank 45. The noncontact thermometer 48 measures a temperature of the hollow core that was slowly cooled when passing through the heating cylinder 42.

The die 20, the heating cylinder 42, the air-cooling portion 44 and the water-cooling tank 45 are disposed in this order, and can move on a rail 52 fixed to a pedestal 50 (see the arrow in FIG. 2), and they are supported such that they can be fixed to any positions. A direction of the hollow core 10 cooled by the water-cooling tank 45 is converted by a sheave 54 provided in the water-receiving water tank 47, the hollow core 10 is introduced by a downstream Nelson roller 56 and then, it is sent to a winding device (not shown). An outer diameter of the hollow core 10 led out from the Nelson roller 56 is measured by a swinging outer diameter measuring device 58.

The die 20 is not especially limited only if it can form the insulating coating body 14, but a die shown in FIGS. 3 to 5 can be used, for example. FIG. 3 is a conceptual diagram showing one example of the die 20 used for the producing method of the invention. FIG. 4 is an enlarged view of a portion A shown in FIG. 3. FIG. 5 is a plan view of the die 20 as viewed from a tip end shown in FIG. 3.

A cross section of the die 20 is formed into a substantially convex shape, and the die 20 includes a disk-shaped flange 22 and a tip end convex portion 24. A pipe 26 is inserted and fitted into a core of the tip end convex portion 24 shown in these drawings, whereby an insertion center hole 24a of the inner conductor 12 is provided (see FIG. 5).

An inner annular hole 24b is disposed adjacent to an outer periphery of the center hole 24. Six straight holes 24c radially extend outwardly from an outer periphery of the inner annular hole 24b substantially at equal distances from one another. An outer annular hole 24d connecting outer ends of the six straight holes 24c with each other is provided between the outer ends of the straight holes 24c.

Using the die 20, the inner conductor 12 is inserted into the center hole 24a and in this state, the molten resin is extruded from the inner annular hole 24b, the straight holes 24c and the outer annular hole 24d. Thereafter, if the molten resin is cooled and solidified, the hollow core 10 having a cross section shape shown in FIG. 1 can be obtained. The inner conductor 12 is rotated, or not rotated, or SZ-rotated and in this state, the inner conductor 12 is inserted into a cross head die, and the molten resin is extruded and coated on the outer periphery of the inner conductor 12, whereby the insulating coating body 14 can be formed.

In this case, the inner annular portion 14a that coats the inner conductor 12 is made of resin extruded from the inner annular hole 24b, the six ribs 14b radially extending from the inner annular portion 14a are made of resin extruded from the straight holes 24c, and the outer annular portion 14c connecting the outer ends of the ribs 14b with each other is made of resin extruded from the outer annular hole 24d. In this invention, it is preferable that the molten resin is extruded from the die 20 while introducing inner-pressure adjusting air into the plurality of hollow portions 16 surrounded by the inner annular portion 14a, the ribs 14b and the outer annular portion 14c.

The inner-pressure adjusting air is disposed one each in a portion surrounded by the inner annular hole 24b, the straight holes 24c and the outer annular hole 24d. When the inner conductor 12 is inserted into the center hole 24e and this is taken out at a predetermined speed, outside air is introduced into the hollow portions 16 from a rear end (corresponding to the left end in FIG. 3) of the through hole 24e together with air flow flowing forward, and the internal pressures in the hollow portions 16 can be equalized.

The inner-pressure adjusting air may be introduced into the hollow portions 16 by air flow that is naturally generated when the inner conductor 12 is taken out, but it is preferable that the inner-pressure adjusting air that is pressurized to a predetermined pressure is positively introduced into the hollow portions 16.

A heating cylinder 24 (draft zone) heats resin forming the insulating coating body 14 pulled out from the die 20. The heating temperature can appropriately be set in accordance with a kind of resin, an outer diameter of the hollow core and the like, and the resin can be heated in a range lower than (melting point of that resin +10° C.) to (room temperature +50° C.) or higher, for example. By passing the resin through the heating cylinder 24 having such temperature, it is possible to obtain the hollow core 10 having excellent roundness although its diameter is small. Even if heat capacity of the molten resin extruded from the die 20 is small, it is possible to prevent the molten resin from being cooled rapidly by passing the resin through the heating cylinder 42. The melting point of resin can be measured by ASTM D4591. The structure and the heating method of the heating cylinder 42 are not limited, but it is preferable that they are heated by high-frequency heating or far-infrared heating.

The air-cooling portion 44 slowly cools, by air, resin forming the insulating coating body 14 at a value close to room temperature. By providing the air-cooling portion 44 behind the heating cylinder 42, it is possible to prevent resin forming the insulating coating body 14 from being cooled and solidified at a stroke. The temperature of the air-cooling portion 44 is about the room temperature, but more specifically, preferably in a range from 15° C. to 40° C., and more preferably in a range from 25° C. to 35° C. By adjusting the length (air-cooling zone) of the air-cooling portion 44, it is possible to adjust the temperature of the molten resin to a target value.

In the producing method of the hollow core for the coaxial cable according to the invention, means for slowly cooling the resin forming the insulating coating body 14 is not limited to the embodiment, and, for example, the resin may slowly be cooled by wind or air. Since the very thin hollow core 10 has small heat capacity, it is possible to lower the temperature of the resin forming the insulating coating body 14 to a value close to the room temperature by air or wind.

For example, when resin is cooled by wind, a conventionally known wind-cooling cylinder can be used as a wind-cooling portion. The wind-cooling cylinder may be provided with a hot-wind generator having a blower, and hot wind having a predetermined temperature may positively be generated. When the wind-cooling portion is used also, like the air-cooling portion 44, it is preferable that atmospheric temperature in the wind-cooling portion is almost equal to the room temperature. Both the air-cooling portion and wind-cooling portion may be used.

The water-cooling tank 45 water-cools the molten resin that passed through the air-cooling portion 44. By this operation, the resin forming the insulating coating body 14 can completely be solidified. The water-cooling tank 45 is not absolutely required in this invention, but it is preferable that the water-cooling tank 45 is provided in addition to the air-cooling portion 44 (or wind-cooling portion). If the hollow core 10 has a very thin diameter, it is possible to lower the temperature of the resin forming the insulating coating body 14 to a value close to the room temperature by air-cooling or wind-cooling as described above, but if the water-cooling is carried out, a hollow core 10 having high roundness can be obtained even if the producing speed is high. Especially, even if a pulling-out speed is 30 m/minute or higher, a hollow core 10 having high roundness can suitably be obtained.

It is preferable that the maximum outer diameter and the minimum outer diameter of the obtained hollow core 10 are measured, and conditions of the heating cylinder 42 and the air-cooling portion 44 are controlled such that the difference between the maximum outer diameter and the minimum outer diameter becomes minimum.

The maximum outer diameter and the minimum outer diameter can be measured by the swinging outer diameter measuring device 58. The swinging outer diameter measuring device 58 can measure the outer diameter of the hollow core 10 continuously or intermittently. It is possible to measure the diameter while reciprocating, swinging and rotating the measuring device itself through 180°, and to measure the outer diameter in the entire circumferential direction of the hollow core 10 online. In this invention, a kind of the measuring device is not limited, and it is possible to measure using appropriate measuring device and measuring method.

Concerning the heating cylinder 42, it is possible to control at least one of its heating temperature and heating time. This can be done by adjusting the atmospheric temperature in the heating cylinder 42, a length of the cylinder (zone length) or the like. It is also possible to control the heating timing of the heating cylinder 42. For example, the producing apparatus S can appropriately move the heating cylinder 42 on the rail 52 and thus, it is possible to control the heating timing of molten resin pulled out from the die 20. If the temperature is low or the heating cylinder is too short, the outer annulus of the hollow portion is prone to swell into a petal shape, and if the temperature is too high or the heating cylinder is too long, the outer annulus of the hollow portion is dented and crushed into a polygonal shape in which the ribs form its apexes. These conditions can be determined while taking, into consideration, a pulling out speed of the inner conductor 12, a temperature measured by the noncontact thermometer 48, and size or shape of the hollow core 10.

Concerning the air-cooling portion 44, it is possible to control the air-cooling condition (air-cooling temperature and air-cooling time) by adjusting the atmospheric temperature, the length of the air-cooling portion (zone length) and the like. It is preferable that the air-cooling timing of the air-cooling portion 44 is controlled, and, for example, the producing apparatus S can control the timing by appropriately moving the air-cooling portion 44 on the rail 52.

Concerning the heating cylinder 42, the air-cooling portion 44 and the like, when starting the producing operation, they are moved on the pedestal 50 to detect the optimal disposition locations (disposition intervals) based on a measurement result of the swinging outer diameter measuring device 58, and after the optimal disposition locations are determined, they can be fixed to the optimal disposition locations (disposition intervals).

According to the invention, the hollow core 10 can integrally be formed. For example, a method in which insulating coating is carried out using divided porous dies, a method in which first coating is carried out in a rib structure and coating is carried out in two stages annularly, and the like are carried out conventionally. However, in the former method, it is necessary that the divided holes are adjacent to each other to adhere the divided portions, a draft ratio can not be increased for this reason, there is a possibility that the divided portion is cracked, and this method has a problem in terms of stability of shape. In the latter method, since the annular coating and the rib structure (cross portion) are adhered to each other, the annular coating itself requires a fastening force, and if the thickness of the annular coating is thin, it is crushed into a polygonal shape. For these reasons, to secure the roundness, it is necessary to increase the thickness, and the hollow rate is lowered. On the other hand, in the invention, it is possible to integrally form the thin hollow core 10 having high hollow rate and excellent roundness.

According to the invention, it is possible to obtain the thin hollow core having high hollow rate and excellent roundness. With this, the hollow core has low dielectric constant and uniform electric characteristics in the longitudinal direction.

### EXAMPLES

The present invention is described in detail based on examples, but the invention is not limited to the examples.

### Example 1

### Example in which Preferable Shape can be Obtained by Heat Cylinder

The hollow core 10 was produced using the producing apparatus shown in FIG. 2.

As the inner conductor, tin-plated tin alloy wires of 7/0.025 mm (wires obtained by stranding seven tin-plated tin alloy wires having an outer diameter of 0.025 mm, the same as above hereinafter) were introduced into a cross head die having a temperature of 350° C., the wires were made to pass through the die 20 having an opening shown in FIG. 5 at a speed of 35 m/minute, and the wires were coated with PFA resin (“AP201SH” produced by DAIKIN INDUSTRIES, LTD., dielectric constant was 2.1, resin melting point was about 310° C.). The heating cylinder 42 (draft zone) having a length of 300 mmm and atmospheric temperature of 250° C., and the air-cooling portion 44 (air-cooling zone) having a length of 500 mm and room temperature (average temperature was 30° C.) were provided directly below the die 20. The area-drafting magnification ratio was 1936 times, and a hollow core having an outer diameter of 0.19 mm was obtained.

### [Evaluation of Shape]

The obtained hollow core 10 was cut and size thereof was measured, a thickness of the outer annular portion was 0.011 mm, a thickness of the rib was 0.012 mm, and a thickness of the inner annular portion was 0.014 mm. A hollow rate of the hollow portion 16 obtained from these measurement results was 48%, and a core close to perfect circle having the roundness of 98.3% could be obtained.

### [Evaluation of Capacitance]

Capacitance of the hollow core was continuously measured underwater online. The capacitance was measured using a cable capacitance monitor (a detector CP-05-10, a repeater CPM-011, and a display CPM-401), a calibration capacitance and a return-loss calculation software CPM-PC (all of them are produced by Takikawa Engineering Co., Ltd.: electrode length of 100 MM, averaging 100 times), and the capacitance was 79.4±0.8 pF/m (between 5 m). The rate of variability of the underwater capacitance was 1.6/79.4×100=2.02(%).

### [Evaluation of Coaxial Cable]

The hollow core 10 was provided with 15 laterally wound shields of 0.03 mm, a jacket having a thickness of 0.05 mm was coated, and a coaxial cable of φ0.35 mm was obtained. The impedance of this coaxial cable was measured using TDR (Time Domain Refrectometry) measuring device (produced by Agilent Technologies: 86100C-TDR mode), and the impedance characteristics were stable in the longitudinal direction as stable as 50.2±0.5Ω (test piece length was 5 m). The rate of variability of the characteristic impedance was 1/50.2×100=1.99%. In the following examples and comparative examples, the evaluation was carried out under the same condition as that of the example 1 unless otherwise specified.

### Comparative Example 1

### No Heat Cylinder, an Example in which a Suitable Shape can not be Obtained by Air Cooling Only

As the inner conductor, tin-plated tin alloy wires of 7/0.025 mm were introduced into a cross head die having a temperature of 350° C., the wires were made to pass through the die 20 at a speed of 35 m/minute, and the wires were coated with PFA resin.

The heating cylinder 42 was not provided directly below the die 20, and an air-cooling zone having a length of 800 mm and temperature of 30° C. was provided.

### [Evaluation of Shape]

A hollow core having an outer diameter of 0.40 mm was obtained, and an area-drafting magnification ratio was 437 times.

The obtained hollow core was cut and size thereof was measured. As a result, a large gap was created between the inner annular portion and the inner conductor. The roundness of the outer annular portion was also low. It was designed that if the inner conductor and the inner annular portion were brought into intimate contact with each other, it became 0.19 mm, but it was considered that this was because that the insulating coating resin was solidified before intimate contact.

### Example 2

### Example in which Suitable Shape is Obtained by the Heating Cylinder

Using the producing apparatus shown in FIG. 2, the hollow core 10 was produced.

As the inner conductor, tin-plated tin alloy wires of 7/0.025 mm (wires obtained by stranding seven tin-plated tin alloy wires having an outer diameter of 0.025 mm, the same as above hereinafter) were introduced into a cross head die having a temperature of 350° C., the wires were made to pass through the die 20 having an opening shown in FIG. 5 at a speed of 35 m/minute, and the wires were coated with PFA resin (“AP201SH” produced by DAIKIN INDUSTRIES, LTD., dielectric constant was 2.1, resin melting point was about 310° C.).

The heating cylinder 42 (draft zone) having a length of 300 mm and atmospheric temperature of 150° C., and the air-cooling portion 44 (air-cooling zone) having a length of 500 mm and room temperature (average temperature was 30° C.) were provided directly below the die 20.

The area-drafting magnification ratio was 1936 times, and a hollow core having an outer diameter of 0.18 mm was obtained.

### [Evaluation of Shape]

The obtained hollow core 10 was cut and size thereof was measured. As a result, a thickness of the outer annular portion was 0.011 mm, a thickness of the rib was 0.012 mm, and a thickness of the inner annular portion was 0.014 mm.

The hollow rate of the hollow portion 16 obtained from the measurement result was 48%, and the roundness was 98.3%.

### [Evaluation Of Capacitance]

The capacitance of the hollow core was continuously measured underwater online. This was measured using the same method as that of the example 1, and the capacitance was 82.0±0.3 pF/m (between 5 m). A rate of variability of the underwater capacitance was 0.6/82.0×100=0.7(%).

### [Evaluation of Coaxial Cable]

The hollow core 10 was provided with 15 laterally wound shields of 0.03 mm, a jacket having a thickness of 0.05 mm was coated, and a coaxial cable of φ0.35 mm was obtained. The impedance of this coaxial cable was measured using TDR measuring device, the impedance characteristics were stable in the longitudinal direction as stable as 50.2±0.2Ω (between 5 m test bodies). The rate of variability of the impedance was 0.4/50.2×100=0.8(%).

### Comparative Example 2

### Example in which Temperature of Heating Cylinder is Too High

As the inner conductor, tin-plated tin alloy wires of 7/0.025 mm were introduced into a cross head die having a temperature of 350° C., the wires were made to pass through the die 20 at a speed of 35 m/minute, and the wires were coated with PFA resin.

The heating cylinder 42 having a length of 300 mm and atmospheric temperature of 320° C., and the air-cooling zone having a length of 500 mm and temperature of 30° C. were provided directly below the die 20.

The area-drafting magnification ratio was 1936 times, and a hollow core having an outer diameter of 0.19 mm was obtained.

### [Evaluation of Shape]

The obtained hollow core was cut and size thereof was measured. As a result, a thickness of the outer annular portion was 0.012 mm, a thickness of the rib was 0.012 mm, and a thickness of the inner annular portion was 0.015 mm. The hollow rate of the hollow portion 16 obtained from these values was 44% and the roundness was 94%. However, a cross section shape of the hollow core was substantially hexagonal shape in which the ribs form its apexes.

### Comparative Example 3

### Example Wherein Temperature of Heating Cylinder is Low, and Heating Time is Long

As the inner conductor, tin-plated tin alloy wires of 7/0.025 mm were introduced into a cross head die having a temperature of 350° C., the wires were made to pass through the die 20 at a speed of 35 m/minute, and the wires were coated with PFA resin.

A heating cylinder having a length of 800 mm and temperature of 100° C. was provided directly below the die 20.

The area-drafting magnification ratio was 777 times, and a hollow core having an outer diameter of 0.30 mm was obtained.

### [Evaluation of Shape]

The obtained hollow core was cut and size thereof was measured. As a result, a thickness of the outer annular portion was 0.015 mm, a thickness of the rib was 0.015 mm, and a thickness of the inner annular portion was 0.017 mm. The hollow rate of the hollow portion 16 obtained from these values was 44% and the roundness was 90% and the hollow core was substantially ellipse in shape. A cross section shape of the hollow core has a large space between the inner annular portion and the inner conductor.

### Example 3

### Example in which Inner Conductor of 7/0.03 mm was Used

As the inner conductor, tin-plated tin alloy wires of 7/0.03 mm were introduced into a cross head die having a temperature of 350° C., the wires were made to pass through the die 20 at a speed of 35 m/minute, and the wires were coated with PFA resin.

The heating cylinder 42 having a length of 300 mm and atmospheric temperature of 250° C., and the air-cooling portion 44 having a length of 500 mm and room temperature (average temperature was 30° C.) were provided directly below the die 20.

The area-drafting magnification ratio was 1213 times, and a hollow core having an outer diameter of 0.24 mm was obtained.

### [Evaluation of Shape]

The obtained hollow core 10 was cut and size thereof was measured. As a result, a thickness of the outer annular portion was 0.016 mm, a thickness of the rib was 0.016 mm, and a thickness of the inner annular portion was 0.018 mm.

The hollow rate of the hollow portion 16 obtained from these values was 46% and the roundness was 98.3% and the hollow core 10 having substantially perfect circle could be obtained.

### [Evaluation of Capacitance]

The capacitance of the hollow core was continuously measured underwater online. This was measured using the same method as that of the example 1, and the capacitance was 80.3±0.3 pF/m (between 5 m). A rate of variability of the underwater capacitance was 0.6/80.3×100=0.7(%).

### [Production of Coaxial Cable]

A coaxial cable was produced using this hollow core 10. The obtained insulating coating body was subjected to etching processing by wet blast, hydrophilic processing by fluoro etching (naphthalene.sodium complex), activating processing by hydrochloric acid liquid of tin(II) chloride, electroless copper plating and electrolytic copper plating, and an outer conductor layer having a thickness of 5 μm was formed. As a protecting coating layer, the cable was coated with PFA coating having a thickness of 0.05 mm, and a very thin coaxial cable having an outer diameter of 0.34 mm could be obtained. Impedance of the coaxial cable was measured based on the same method as that of the example 1, and the impedance characteristics in the longitudinal direction were as stable as 50.9±0.2Ω (between 5 m test bodies). The rate of variability of the characteristic impedance was 0.4/50.9×100=0.8(%).

### Comparative Example 4

### Example in which the Heating Cylinder (Draft Zone) in the Example 3 is Eliminated

As the inner conductor, tin-plated tin alloy wires of 7/0.03 mm were introduced into a cross head die having a temperature of 350° C., the wires were made to pass through the die 20 at a speed of 35 m/minute, and the wires were coated with PFA resin.

The heating cylinder was not provided and an air-cooling zone having a length of 800 mm and temperature of 30° C. was provided directly below the die 20. A hollow core having an outer diameter of 0.41 mm was obtained, and the area-drafting magnification ratio was 415 times.

### [Evaluation of Shape]

The obtained hollow core was cut and size thereof was measured. As a result, a large gap was created between the inner conductor and the inner annular portion.

### Comparative Example 5

### Example in which Outer Diameter is 0.19 mm, and the Insulating Layer is of PTFE Laterally Wound Insulating Layer

A PTFE porous tape (hollow rate: 50%) having a thickness of 0.06 mm was laterally wound around a tin-plated tin alloy having 7/0.025 mm that is the inner conductor, and an insulating core having an outer diameter of 0.19 mm was obtained. Capacitance of the obtained core body was measured and was 82.2±2.0 pF/m (between 5 m). A value of variable of this capacitance was 4.0/82.2×100=4.87%.

### [Evaluation of Coaxial Cable]

The hollow core was provided with 15 laterally wound shields of 0.03 mm, a jacket having a thickness of 0.05 mm was coated, and a coaxial cable of φ0.36 mm was obtained. The impedance of this coaxial cable was measured using TDR (Time Domain Refrectometry) measuring device, the impedance characteristics were 50.5±1.25Ω and were varied in the longitudinal direction. The rate of variability of the characteristic impedance was 2.5/50.5×100=4.95%.

### Example 4

### Example of Coaxial Cable Having Outer Diameter of 0.49 mm)

As the inner conductor, tin-plated copper wires of φ7/0.065 mm were introduced into a cross head die having a temperature of 350° C., the wires were made to pass through the die 20 at a speed of 30 m/minute, and the wires were coated with PFA resin.

The heating cylinder 42 (draft zone) having a length of 300 mm and atmospheric temperature of 210° C., and the air-cooling portion 44 (air-cooling zone) having a length of 500 mm and room temperature (average temperature was 30° C.) were provided directly below the die 20. The area-drafting magnification ratio was 300 times, and a hollow core having an outer diameter of 0.49 mm was obtained.

### [Evaluation of Shape]

The obtained hollow core 10 was cut and size thereof was measured. As a result, a thickness of the outer annular portion was 0.033 mm, a thickness of the rib was 0.033 mm, and a thickness of the inner annular portion was 0.029 mm. A hollow rate of the hollow portion 16 obtained from these measurement results was 46%, and a core having the roundness of 98.6% close to the perfect circle could be obtained.

### [Evaluation of Capacitance]

The capacitance of the hollow core was measured underwater online and was 82.0±0.7 pF/m (between 5 m). The rate of variability of the underwater capacitance was 1.4/82.0×100=1.7(%).

### [Evaluation of Coaxial Cable]

The hollow core was provided with 15 laterally wound shields of 0.05 mm, a jacket having a thickness of 0.10 mm was coated, and a coaxial cable of φ0.79 mm was obtained. The impedance of this coaxial cable was measured using TDR measuring device, the impedance characteristics were stable in the longitudinal direction as stable as 50.0±0.45Ω (test piece length was 5 m). The rate of variability of the characteristic impedance was 0.9/50.0×100=1.8%.

### Comparative Example 6

### Example in which Outer Diameter is 0.49 mm and Coaxial Cable is of Foam-Type

As the inner conductor, tin-plated copper wires of 7/0.065 mm were introduced into a cross head die having a temperature of 350° C., the wires were coated with PFA resin having extent of gas foaming of 59%, and a core body of 0.49 mm was obtained.

[Evaluation of Capacitance]

The capacitance of the hollow core was measured underwater online and was 82.0±1.4 pF/m (between 5 m). The rate of variability of the underwater capacitance was 2.8/82.0×100=3.4(%).

### [Evaluation of Coaxial Cable]

The hollow core was provided with 15 laterally wound shields of 0.05 mm, a jacket having a thickness of 0.1 mm was coated, and a coaxial cable having an outer diameter of 0.79 mm was obtained. The impedance of this coaxial cable was measured using TDR measuring device, and the impedance characteristics were 50.0±0.85Ω and varied. The rate of variability of the characteristic impedance was 1.7/50.0×100=3.4%.

### Example 5

### Example of Coaxial Cable Having Outer Diameter of 0.49 mm, and Shape is Corrected by Cooling Temperature

As the inner conductor, tin-plated copper wires of 7/0.065 mm were introduced into a cross head die having a temperature of 350° C., the wires were made to pass through the die 20 at a speed of 40 m/minute, and the wires were coated with PFA resin.

The heating cylinder 42 (draft zone) having a length of 300 mm and atmospheric temperature of 170° C., and the air-cooling portion 44 (air-cooling zone) having a length of 500 mm and room temperature (average temperature was 30° C.) were provided directly below the die 20. The area-drafting magnification ratio was 300 times. A core having the maximum diameter of 0.485 mm, the minimum diameter of 0.475 mm, and stable roundness of 97.9% was obtained.

### Comparative Example 7

A hollow core was obtained under the same conditions as those of the example 5 except that the cooling zone temperature was 210° C., the maximum diameter was 0.490 mm, the minimum diameter was 0.470 mm, the roundness was 95.8%, and its shape was hexagonal.

### Example 6

### Drafting Magnification Ratio of 4000 Times

As the inner conductor, tin-plated tin alloy wires of 7/0.018 mm were introduced into a cross head die having a temperature of 350° C., the wires were made to pass through the die 20 at a speed of 35 m/min, and the wires were coated with PFA resin.

The heating cylinder 42 having a length of 300 mm and atmospheric temperature of 250° C., and the air-cooling portion 44 having a length of 500 mm and room temperature (average temperature was 30° C.) were provided directly below the die 20.

The area-drafting magnification ratio was 3723 times, and a hollow core having an outer diameter of 0.137 mm was obtained.

### [Evaluation of Shape]

The obtained hollow core 10 was cut and size thereof was measured. As a result, a thickness of the outer annular portion was 0.01 mm, a thickness of the rib was 0.009 mm, and a thickness of the inner annular portion was 0.009 mm.

The hollow rate of the hollow portion 16 obtained from these measurement results was 45%, and the roundness was 98.3%, and a hollow core 10 close to the perfect circle could be obtained.

### [Evaluation of Capacitance]

The capacitance of the hollow core was continuously measured underwater online. This was measured using the same method as that of the example 1, and the capacitance was 83.3±1.0 pF/m (between 5 m).

The rate of variability of the underwater capacitance was 2.0/83.3×100=2.4(%).

### [Production of Coaxial Cable]

A coaxial cable was formed using the hollow core 10. The obtained insulating coating body was subjected to etching processing by wet blast, hydrophilic processing by fluoro etching (naphthalene.sodium complex), activating processing by hydrochloric acid liquid of tin(II) chloride, electroless copper plating, and electrolytic copper plating, and an outer conductor layer having a thickness of 5 μm was formed. As a protecting coating layer, the cable was coated with PFA coating having a thickness of 0.05 mm, and a very thin coaxial cable having an outer diameter of 0.247 mm could be obtained. Impedance of the coaxial cable was measured based on the same method as that of the example 1, and the impedance characteristics in the longitudinal direction were as stable as 49.7±0.7Ω (between 5 m test bodies). The rate of variability of the characteristic impedance was 1.4/49.7×100=2.8(%).

The producing method of the invention showed that it was possible to produce a hollow core having stable electric characteristics in its longitudinal direction having a high hollow rate like the hollow core of the invention. As the hollow core, the outer diameter of the outer annular portion could be 0.5 mm or less, a ratio of area of the hollow portion in the insulating portion could be 40% or more, and the roundness of the outer annular portion could be 96.0% or more. The producing method also showed such a stable electric characteristics that the rate of variability of the underwater capacitance in the longitudinal direction was 3.1% or less (see examples 1 to 6). It was found that the coaxial cable produced from the hollow core had stable rate of variability of characteristic impedance in the longitudinal direction as stable as 3.0% or less (see examples 1 to 6).

In the comparative examples 1 to 6, a hollow core having stable electric characteristics in its longitudinal direction having a high hollow rate like the hollow core of the invention could not be produced.

### BRIEF DESCRIPTION OF DRAWINGS

FIG. 1 is sectional view showing an embodiment of a hollow core according to the invention.

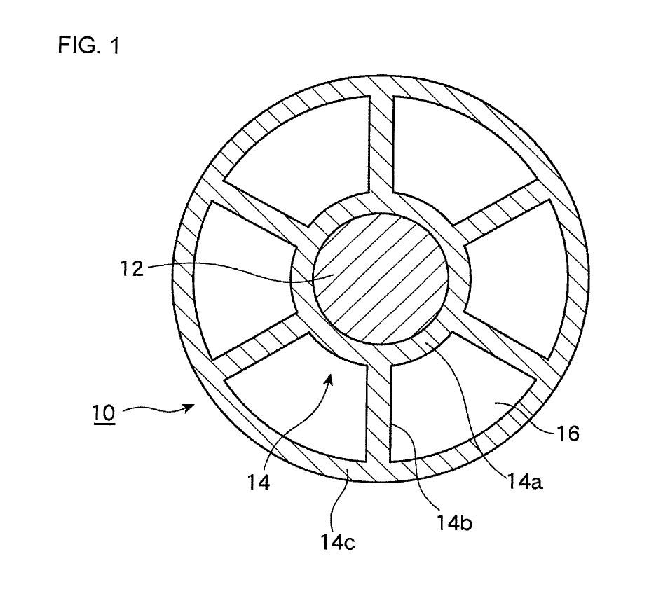

FIG. 2 is a conceptual diagram for explaining one example of a producing method of the invention;

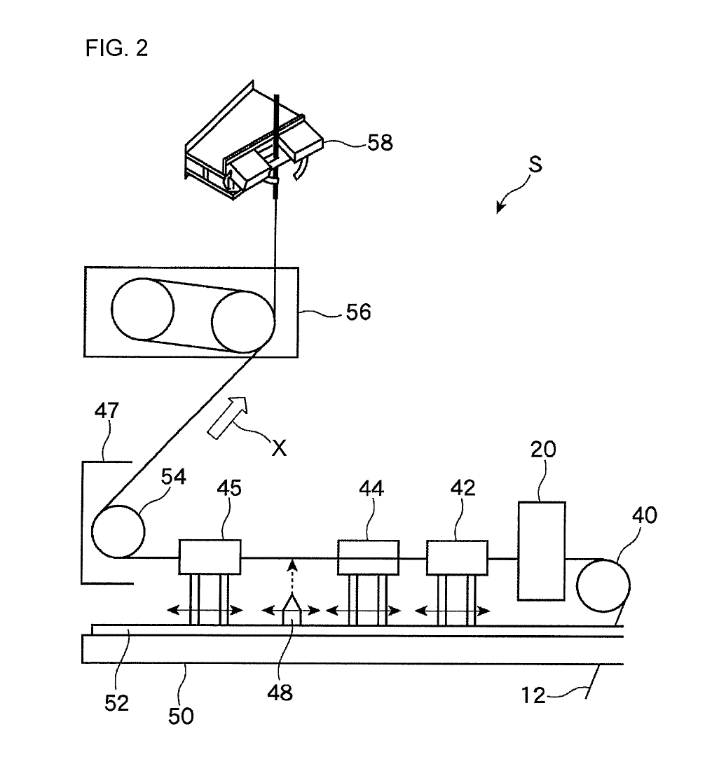

FIG. 3 is a conceptual diagram showing one example of a die used in the producing method of the invention;

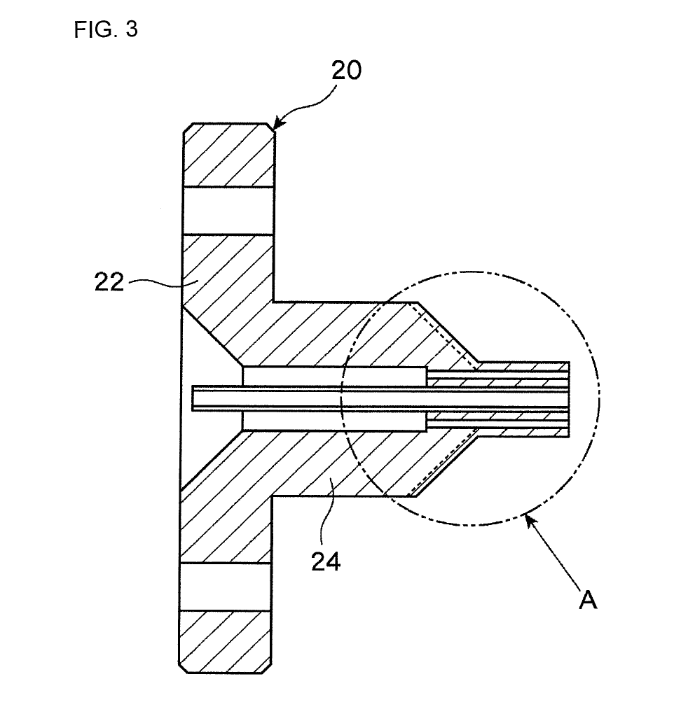

FIG. 4 is an enlarged view of a portion A in FIG. 3; and

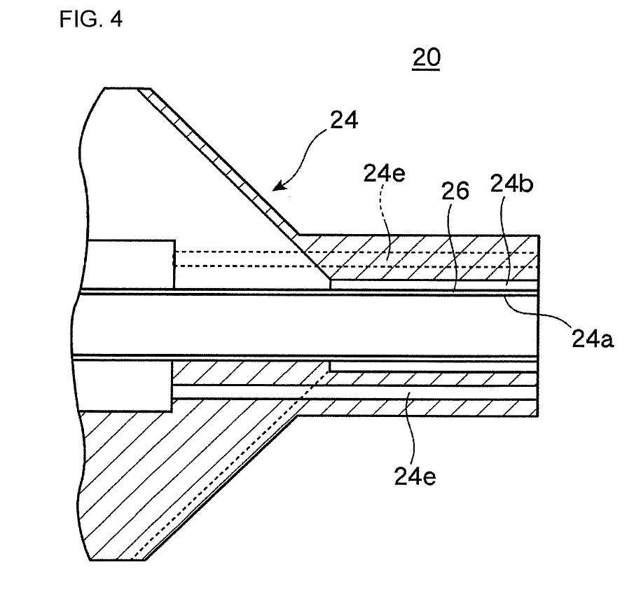

FIG. 5 is a plan view of the die as viewed from its tip end shown in FIG. 3.

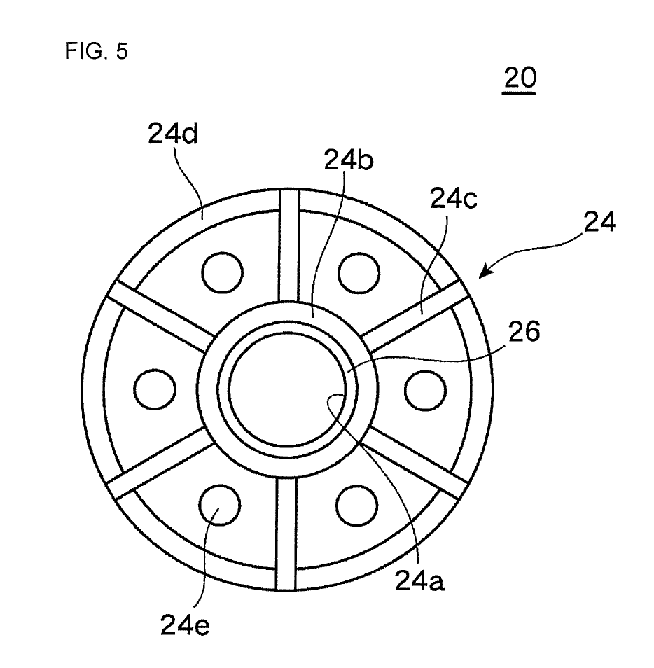

### REFERENCE SIGNS LIST

10 Hollow core for coaxial cable
12 Inner conductor
14 Insulating coating body
14a Inner annular portion
14b Rib
14c Outer annular portion
16 Hollow portion
20 Die
42 Heating portion
44 Wind-cooling portion
45 Water-cooling tank
S Producing apparatus

1. A producing method of a hollow core for a coaxial cable, the hollow core comprising:
an inner conductor; and
an insulating coating body including an inner annular portion for coating the inner conductor, a plurality of ribs extending radially from the inner annular portion, and an outer annular portion having an outer diameter of 0.5 mm or less for connecting outer ends of the ribs with each other; in which
the hollow core includes a plurality of hollow portions surrounded by the inner annular portion, the outer annular portion and the ribs, a ratio of an area of the hollow portion in an insulating portion is 40% or more, and a roundness of the outer annular portion is 96.0% or more, wherein
the producing method comprises at least:
a step (1) of extruding molten resin from the die that capable of forming the insulating coating body;
a step (2) of heating the resin forming the insulating coating body; and
a step (3) of cooling the resin forming the insulating coating body slowly at a temperature close to a room temperature.

2. The producing method of a hollow core for a coaxial cable according to claim 1, wherein the step (2) is carried out by a heating cylinder.

3. The producing method of a hollow core for a coaxial cable according to claim 1, wherein a maximum outer diameter and a minimum outer diameter of the obtained hollow core are measured, and at least one of a heating temperature and heating time in the step (2) is controlled such that a difference between the maximum outer diameter and the minimum outer diameter becomes minimum.

4. The producing method of a hollow core for a coaxial cable according to claim 1, wherein an area-drafting magnification ratio is in a range of 300 to 4000 times.

5. The producing method of a hollow core for a coaxial cable according to claim 1, wherein the die includes an insertion center hole of the inner conductor, an inner annular hole formed adjacent to an outer periphery of the insertion center hole, a plurality of straight holes radially extending from an outer periphery of the inner annular hole, an outer annular hole connecting outer ends of the straight holes with each other, and a through hole through which inner-pressure adjusting air for forming the hollow portion is introduced into a portion surrounded by the inner annular hole, the outer annular hole and the straight holes.

6. A hollow core for a coaxial cable comprising:
an inner conductor; and
an insulating coating body including an inner annular portion for coating the inner conductor, a plurality of ribs extending radially from the inner annular portion, and an outer annular portion having an outer diameter of 0.5 mm or less for connecting outer ends of the ribs with each other; in which
the hollow core includes a plurality of hollow portions surrounded by the inner annular portion, the outer annular portion and the ribs,
a ratio of an area of the hollow portion in the insulating portion is 40% or more, and a roundness of the outer annular portion is 96.0% or more, and
a rate of variability of an underwater capacitance in its longitudinal direction is 3.1% or less.

7. A coaxial cable, wherein at least an outer conductor layer is provided on one or a plurality of outer peripheries of the hollow core for a coaxial cable according to claim 6.

8. The coaxial cable according to claim 7, wherein a rate of variability of a characteristic impedance in its longitudinal direction is 3.0% or less.
